(19) United States
(12) Patent Application Publication
(10) Pub. No.: US 2024/0356152 A1
(43) Pub. Date: Oct. 24, 2024

(54) BATTERY MODULE

(71) Applicant: Trend Power Technology(changshu) Inc., Jiangsu (CN)

(72) Inventors: Chia-Chun CHANG, Hsinchu County (TW); Cheng-Chin CHOU, Hsinchu County (TW); Chao-Kai WANG, Hsinchu County (TW)

(21) Appl. No.: 18/639,940

(22) Filed: Apr. 18, 2024

(30) Foreign Application Priority Data
Apr. 19, 2023 (CN) 202310423145.1
May 19, 2023 (CN) 202310567149.7

(51) Int. Cl. H01M 50/383; H01M 10/6554; H01M 50/367

(52) U.S. Cl. CPC H01M 50/383; H01M 10/6554; H01M 50/367

(57) ABSTRACT

A battery module includes a housing, a cell set disposed inside the housing and at least one baffle assembly. The cell set and the housing defines at least one flame guiding channel. The baffle assembly is perpendicular to the flame guiding channel, and has at least slit communicating to the flame guiding channel, which generates routes of compression and expansion for cooling an airflow of a be expelled combustible gas.

### RELATED APPLICATIONS

This application claims priority to China Application Serial Number 202310423145.1, filed Apr. 19, 2023, and China Application Serial Number 202310567149.7, filed May 19, 2023, which are herein incorporated by reference.

### FIELD OF INVENTION

The present disclosure relates to a power supply module, and more particularly to a battery module.

### DESCRIPTION OF RELATED ARTS

As the market demand for higher battery capacity, the number of cells carried by a battery module increase, which results higher risks of explosion and fire. There are possibilities for a cell to be exploded or to spout a flame if the temperature surrounding the cell is too high, or an internal shortage occurs. Further because of the shield of the outer housing, the flame within the battery module is difficult to dissipate. It may propagate to the adjacent cells resulting a large-scale thermal runaway of the battery module. The large-scale thermal runaway generates a large amount of combustible gas, which is easily to be ignited as it discharged from the housing and to cause fire damages outside of the battery module.

In order to avoid external fires, a metal mesh is commonly provided for sheltering and decreasing the temperature of the combustible gas by means of exchanging heat. However, the heat exchange capacity of the mesh is limited, the temperature of the mesh will gradually increase after heat exchanged. When the heat exchange capacity of the mesh has approached to its saturation, the probability of igniting the combustible gas after passing through the mesh increases.

Therefore, there's a need for a technology to prevent fire damages that avoids the expelled combustible gas being ignited outside the battery module, which enhances the safety of the battery module and further comply with relevant regulations of fire protections and preventions.

### SUMMARY OF THE PRESENT DISCLOSURE

One embodiment of the present application provides a battery module including a housing, a cell set disposed inside the housing and at least one baffle assembly. The cell set and the housing defines at least one flame guiding channel. The baffle assembly is perpendicular to the flame guiding channel, and has at least slit communicating to the flame guiding channel, which generates routes of compression and expansion for cooling an airflow of a be expelled combustible gas.

### BRIEF DESCRIPTION OF THE DRAWINGS

FIG. 1 is an exemplary diagram illustrated a partially schematic battery module in accordance with an embodiment of the present disclosure.

FIG. 2 is a perspective views illustrating a baffle assembly in accordance with an embodiment of the present disclosure.

FIG. 3A and FIG. 3B are diagrams respectively illustrating the relation between pressure and volume, and the relation between temperature and entropy of an airflow flowing through the slit of the baffle assembly.

FIG. 4 is an exemplary diagram illustrated a partial schematic diagram of a battery module in accordance of another embodiment of the present disclosure.

FIG. 5A and FIG. 5B are diagrams respectively illustrating the relation between pressure and volume, and the relation between temperature and entropy of an airflow flowing through the slit of the baffle assembly.

FIG. 6 is an exemplary diagram illustrated a partially schematic battery module in accordance with an embodiment of the present disclosure.

FIG. 7a is a perspective views illustrating a baffle assembly in accordance with an embodiment of the present disclosure.

FIG. 7b is a perspective views illustrating a baffle assembly in accordance with another embodiment of the present disclosure.

FIG. 8 is an exemplary diagram illustrated a partially schematic battery module in accordance with an embodiment of the present disclosure.

FIG. 9 is a perspective views illustrating a baffle assembly in accordance with an embodiment of the present disclosure.

FIG. 10 is an exemplary diagram illustrated a partially schematic battery module in accordance with another embodiment of the present disclosure.

FIG. 11 is an exemplary diagram illustrated a partially schematic battery module in accordance with an embodiment of the present disclosure.

FIG. 12 is an exemplary diagram illustrated a partially schematic battery module in accordance with another embodiment of the present disclosure.

FIGS. 13A-13F are exemplary diagrams illustrated the heat transfer mesh plates with different opening ratios in accordance with other embodiments of the present disclosure.

FIG. 14 is an exemplary diagram illustrated a partially schematic battery module in accordance with another embodiment of the present disclosure.

### DETAILED DESCRIPTION

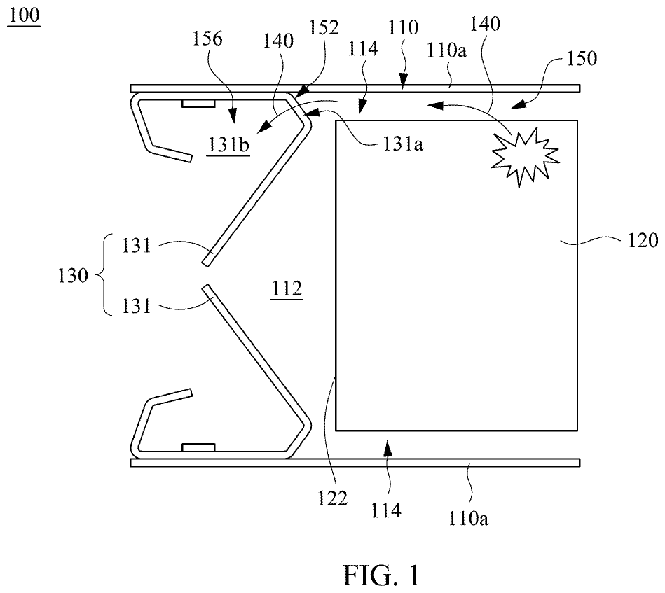

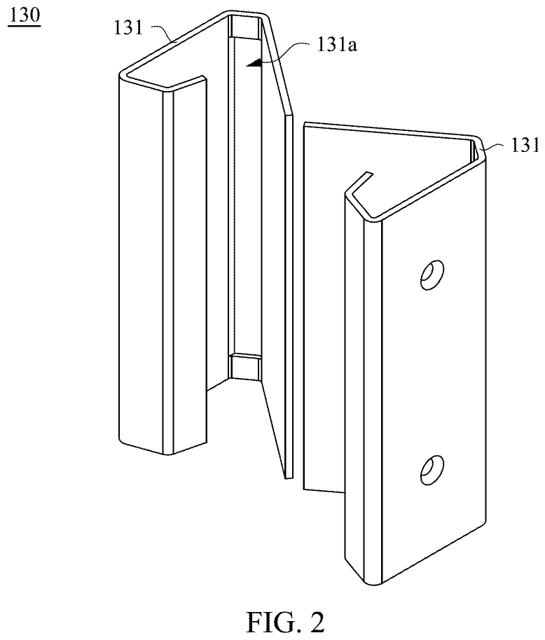

With reference to FIG. 1, FIG. 2, FIG. 1 is an exemplary diagram illustrated a partially schematic battery module in accordance with an embodiment of the present disclosure; and FIG. 2 is a perspective views illustrating a baffle assembly 130 in accordance with an embodiment of the present disclosure. In this embodiment, the battery module 100 may mainly include a housing 110, a cell set 120 and at least one baffle assembly 130. The housing 110 has an accommodation space 112. The cell set 120 is made up with multiple cells placed inside the accommodation space 112. The cell set 120 defines two flame guiding channels 114 corresponding to the side walls 110a of the housing 110 respectively. The baffle assembly 130 is placed inside the accommodation space 112 and may be adjacent to one end 122 of the cell set 120. The baffle assembly 130 is perpendicular to the flame guiding channels 114 and may be mounted on two opposite side walls 110a. The baffle assembly 130 includes two baffle structures 131, and may be made of metal parts, such as iron or steel. Each of baffle structures has a slit 131a communicated to the corresponding flame guiding channels 114, and creates a compression section, an expansion section or both.

In this embodiment, as shown in FIG. 2, the baffle structure 131 is a bended structure which the tension side is protruded inwardly to the cell set 120 and makes the slits 131a close to the flame guiding channels 114. The compression side of the baffle structure 131 forms an expansion section 131b.

When one of the cells in the cell set 120 is in thermal runaway, it generates a high-temperature and high-pressure airflow 140. The flame guiding channels 114 provide dissipated paths for the airflow 140. The airflow 140 is moving ahead to the baffle assembly 130 and is compressed by the slits 131a. The compressed airflow 140 enters the expansion section 131b and expands after passed through the slits 131a, which obtains a cooling effect. Despite no airflow have been compressed as the airflow 140 flows through the flame guiding channel 114 before entering the slits 131a. The compression is defined at where the airflow 140 is compressed as more airflow being exploded from the cell and continue moving toward the slits 131a.

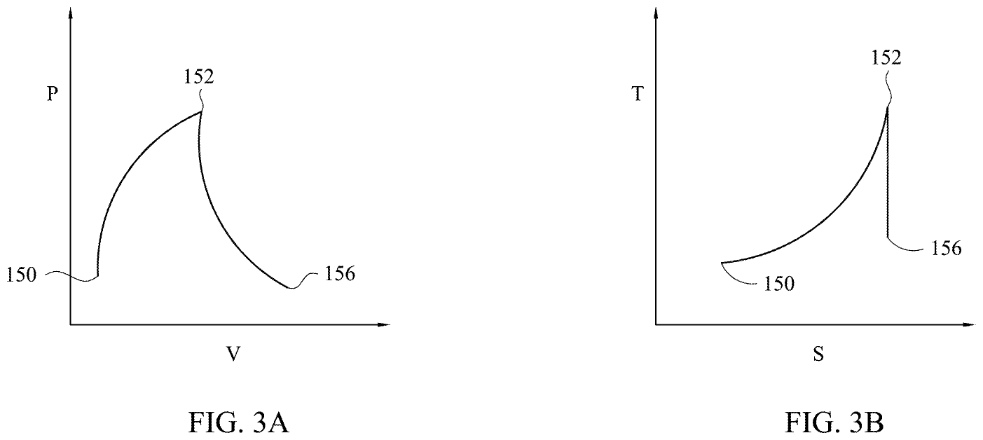

With further reference to FIG. 3A and FIG. 3B, FIG. 3A and FIG. 3B are diagrams respectively illustrating the relation between pressure and volume, and the relation between temperature and entropy of an airflow flowing through the slit of the baffle assembly. As shown in FIG. 3A, when thermal runaway occurred, the position 150 represents low-temperature and low-pressure status which the airflow 140 initially being emitted from the cell set 120.

During the flowing of the airflow 140 towards the slit 131a through the flame guiding channel 114, the pressure and the volume of the airflow 140 continue increases. The pressure and temperature of the airflow 140 have reached to their maximum value at a position 152, which represents the airflow 140 at the slit 131a has maximum compression rate. The compressed airflow 140 then passed through the slit 131a, from the position 152 to the position 156 (i.e., the expansion section 131b), the volume of the airflow 140 increases, but the pressure and the temperature both decreases. Therefore, in ways of open-Brayton cycle theory, the airflow 140 generated by a large-scale burning cell set 120 will flow through the flame guiding channel 114 using baffle assembly 130 before expelled. The temperature of the airflow 140 can be decreased within the battery module 100, which the probability of igniting the expelled airflow is significantly decreased.

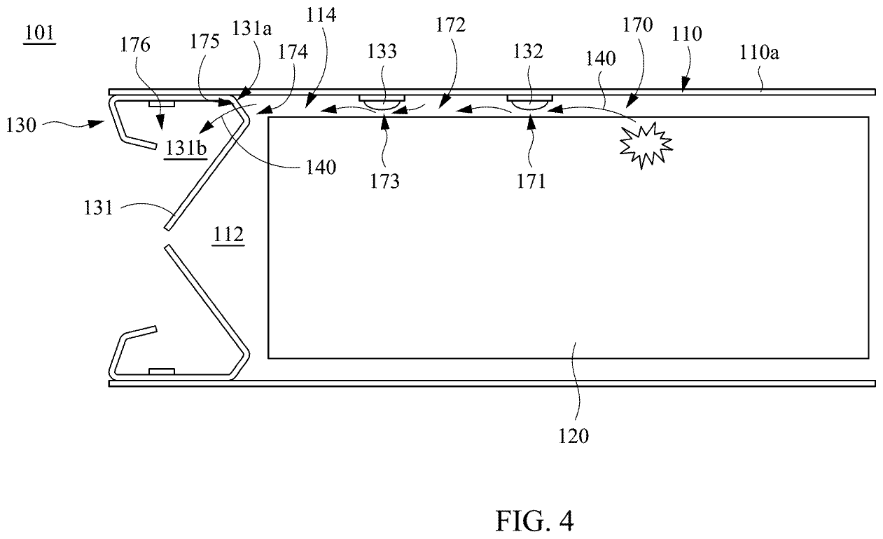

With reference to FIG. 4, FIG. 4 is an exemplary diagram illustrated a partial schematic diagram of a battery module in accordance of another embodiment of the present disclosure. In this embodiment, the structure of the battery module 101 is similar to the battery module 100 which has previously described. The difference between these two embodiments is that the baffle assembly 130 of the battery module 101 does not only have baffle structures 131 but further include one or more bumps. For instance, the two bumps 132, 133 may mounted on the side walls 110a of the housing 110 and protruded toward the cell set 120 within one or two of the flame guiding channels 114. In this manner, the bumps 132, 133 can partially shorten the width of the flame guiding channel 114, so that to provide a compression effect for the airflow 140. Moreover, each of the flame guiding channels 114 may respectively mounted with more than one bumps, and the number of the bumps can be varied.

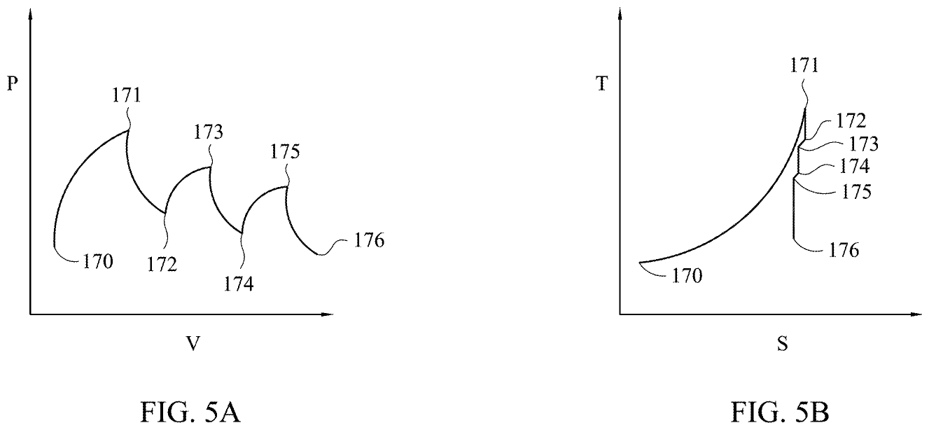

With further reference to FIG. 5A and FIG. 5B, FIG. 5A and FIG. 5B are diagrams respectively illustrating the relation between pressure and volume, and the relation between temperature and entropy of an airflow flowing through the slit of the baffle assembly. When thermal runaway occurred, the position 170 represents low-temperature and low-pressure status which the airflow 140 initially being emitted from the cell set 120.

During the flowing of the airflow 140 within the flame guiding channel 114, the volume continues to increase. Because the compression caused by the bump 132, the pressure and temperature have reached to their maximum value at position 171 while the airflow 140 flowing to a section under the bump 132. After the airflow 140 passing the underneath of the bump 132 and toward the successive bump 133, the position 172 shows that the volume of the airflow 140 increases but the pressure and temperature drops. The airflow 140 is once again being compressed while it flew under the bump 133, which shown at position 173 that the pressure increases but the degree of temperature falling has been slowdown.

Next, the airflow passing the underneath of the bump 133 and toward the baffle assembly 130, the position 174 shows that the pressure has dropped but the degree of temperature falling is increasing. As the airflow 140 arrives the slit 131a of the baffle structure 131, the position 175 shows that the pressure increases and the degree of temperature falling has decreased due to the compression causing by the slit 131a.

Accordingly, by giving several times in routes of compression and expansion, the temperature of the airflow 140 can be decreased. Therefore, the probability of igniting the expelled airflow 140 from the battery module 101 is significantly decreased. The safety of the battery module 101 is enhanced.

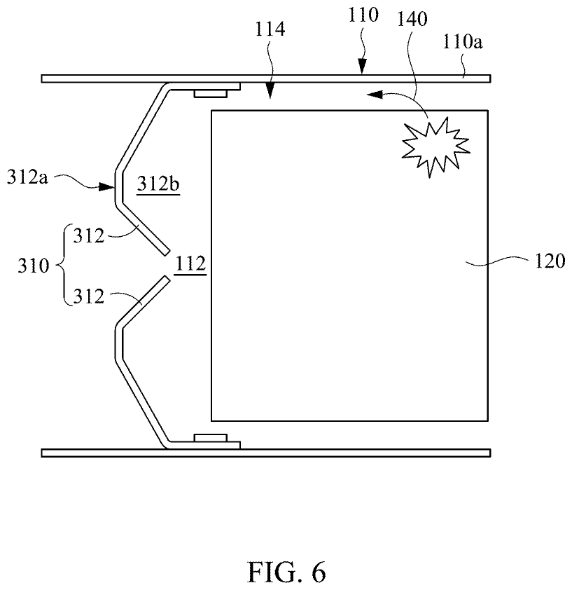

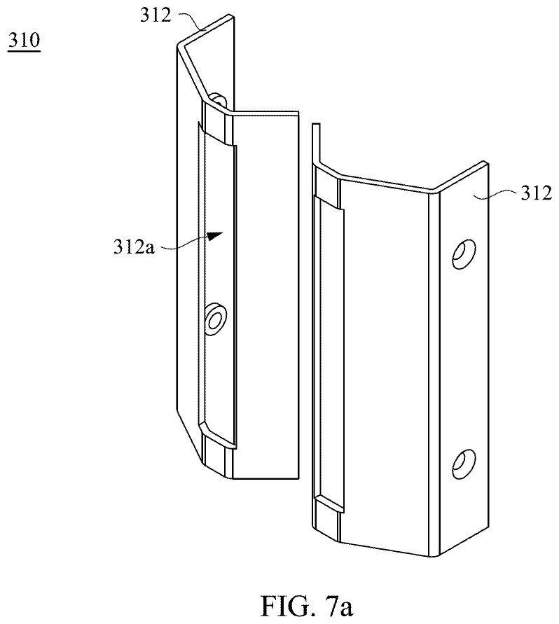

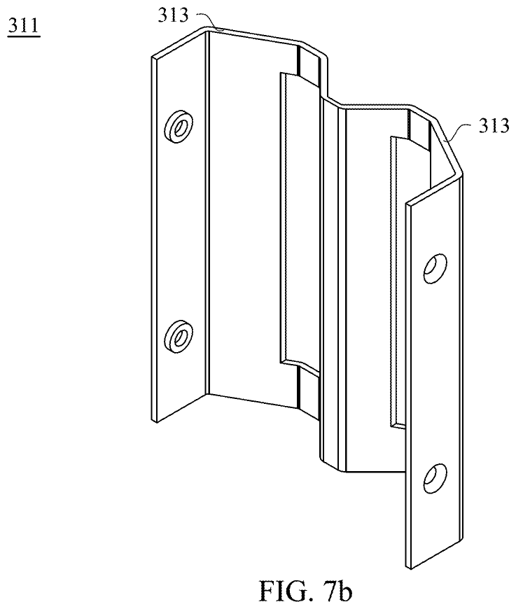

With further reference to FIG. 6 and FIG. 7a, FIG. 6 is an exemplary diagram illustrated a partially schematic battery module in accordance with an embodiment of the present disclosure; and FIG. 7a is a perspective views illustrating a baffle assembly 310 in accordance with an embodiment of the present disclosure. In this embodiment, the tension side of the baffle structure 312 protruded outwardly from the cell set 120, and the slits 312a, which compared to the slit 131a shown in FIG. 2 is far away from the flame guiding channel 114. The compression side of the baffle structure 312 forms a compression section 312b.

When thermal runaway occurred, the airflow 140 expelled from the flame guiding channel 114 will first enter the compression section 312b. The airflow 140 is compressed at the compression section 312b before entering the slit 312a. The compressed airflow 140 is then expelled directly into the external environment. The airflow 140 also undergoes compression and subsequent expansion routes through the baffle assembly 310 to obtain the cooling effect.

With further reference to FIG. 7b, FIG. 7b is a perspective views illustrating a baffle assembly 311 in accordance with another embodiment of the present disclosure. In this embodiment, compared to FIG. 7a, the two baffle structures 312 of the baffle assembly 310 are spaced apart and mounted respectively onto the side walls 110a of the housing 110. Nevertheless, FIG. 7b shows that the two baffle structures 313 are formed in one-piece.

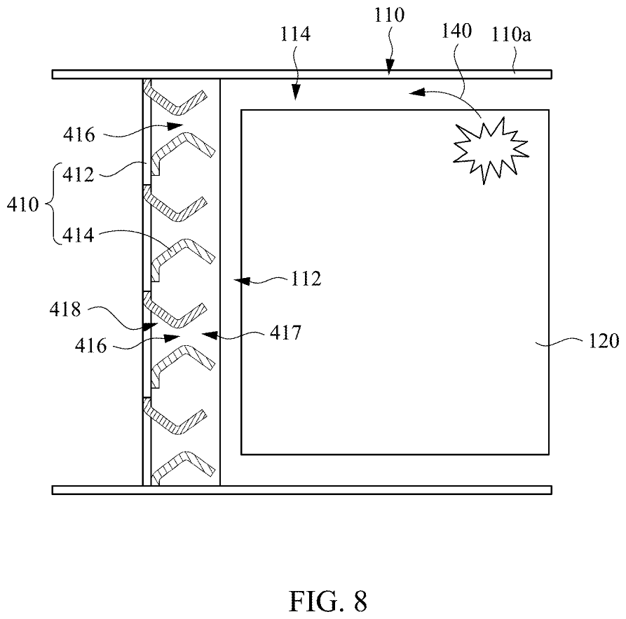

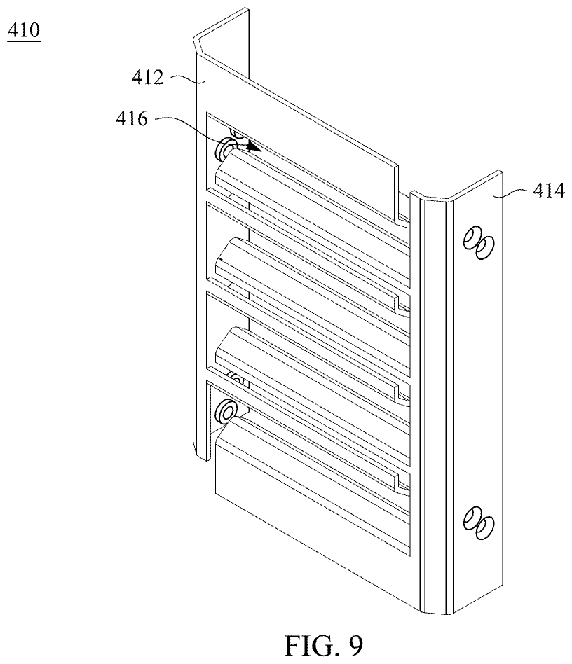

With further reference to FIG. 8 and FIG. 9, FIG. 8 is an exemplary diagram illustrated a partially schematic battery module in accordance with an embodiment of the present disclosure; and FIG. 9 is a perspective views illustrating a baffle assembly 410 in accordance with an embodiment of the present disclosure.

As shown in FIG. 8 and FIG. 9, the baffle assembly 410 has more than two baffle structure. Each baffle structure has a first baffle 412 and a second baffle 414 latitudinal spaced apart to each other that forms a slit 416. The first baffle 412 has a convex portion protruding downwardly and the second baffle 414 has a convex portion protruding upwardly, which defines a compression section 417 and an expansion section 418 respectively at two sides. As shown in FIG. 8, the compression section 417 is in between the slit 416 and the flame guiding channel 114. When thermal runaway occurred, the airflow 140 flows into the compression section 417. The compression sections 417 of the baffle assembly 410 can compress the airflow 140 in advance as the airflow 140 entering the slits 416. The airflow 140 gets further compressed inside the slits 416, and then release to expansion at the expansion section 418. As same as above described, the airflow 140 is cooled through the routes of compression and expansion.

Accordingly, the present disclosure may arrange one or more baffle assemblies 130 according to actual demands. In addition, the structure of the baffle assembly of the present disclosure is not limited to that of the baffle assembly 130 as long as the baffle assembly can provide a path for the airflow 140 to expand after being compressed.

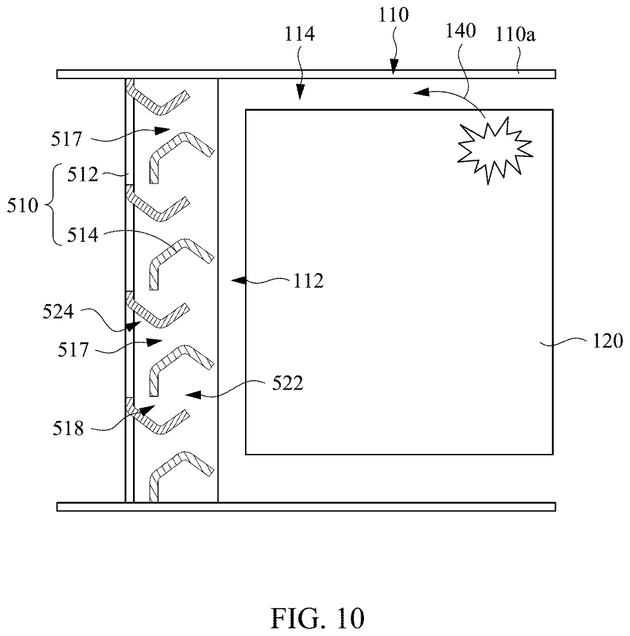

With reference to FIG. 10, FIG. 10 is an exemplary diagram illustrated a partially schematic battery module in accordance with another embodiment of the present disclosure. In this embodiment, the baffle assembly 510 has more than two baffle structures, multiple first slits 517 and multiple second slits 518. Each baffle structure has a first baffle 512 and a second baffle 514 latitudinal spaced apart to each other that forms the first slit 517. The second slit 518 is formed between the second baffle 514 of the baffle structure and the first baffle 512 of the adjacent baffle structure. The first baffle 512 has a convex portion protruding downwardly and the second baffle 514 has a convex portion protruding upwardly, which defines a compression section 522 and an expansion section 524 respectively. The expansion section 524 communicates with the first slit 517, and the compression section 522 communicates with the second slit 518.

When thermal runaway occurred, the airflow 140 may selectively heading to the first slit 517 and the second slit 518. In order to cool down the airflow 140, the airflow 140 may be compressed at first slit 517 then expanded at the expansion section 524. Alternatively, the airflow 140 may be compressed at the compression section 522 then expanded after passed through the second slit 518.

With reference to FIG. 1 and FIG. 11, FIG. 11 is an exemplary diagram illustrated a partially schematic battery module in accordance with an embodiment of the present disclosure. In this embodiment, as shown in FIG. 11, the accommodation space 112 further comprises at least one heat transfer mesh plate 180 paralleled to the baffle assembly 130. The heat transfer mesh plate 180 may selectively place at one or both sides of the baffle assembly 130. In this embodiment, as shown in FIG. 11, the baffle assembly 130 is mounted between the heat transfer mesh plate 180 and the cell set 120. However, the heat transfer mesh plate 180 may also mount between the baffle assembly 130 and the cell set 120. The heat transfer mesh plate 180 may be made of a high heat transfer material, such as metal.

When the expelled airflow 140 that from the baffle assembly 130 which is flowing to the heat transfer mesh plate 180, the heat transfer mesh plate 180 can exchange heat with the airflow 140 for absorbing a portion of the heat of the airflow 140 to further decrease the temperature of the airflow 140. Since the airflow 140 has already cooled by the baffle assembly 130, which is able to maintain the heat exchange capacity of the heat transfer mesh plate 180. The time for a mesh to reach its saturation of heat exchange capacity can be extended.

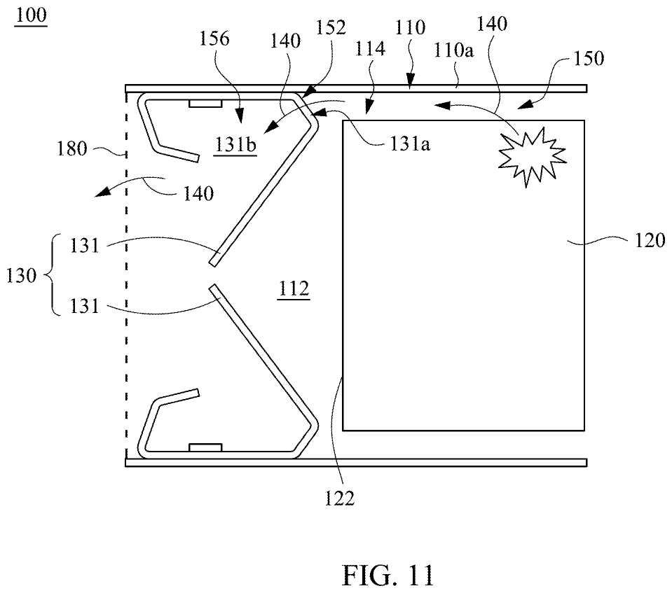

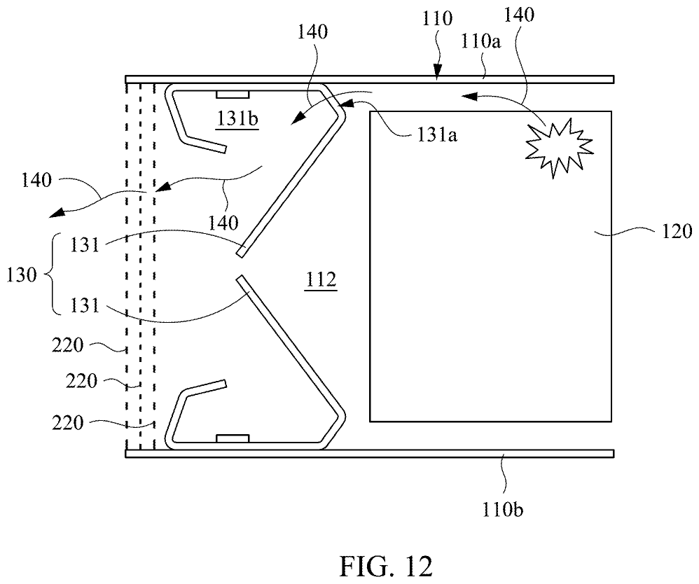

With reference to FIG. 12, FIG. 12 is an exemplary diagram illustrated a partially schematic battery module in accordance with another embodiment of the present disclosure. In this embodiment, the at least one heat transfer mesh plate has multiple heat transfer mesh plates are parallel-arranged in sequence, and each of the heat transfer mesh plates has at least different opening ratio to adjacent heat transfer mesh plates. In some embodiments, the multiple mesh plates may align with or without gaps.

As shown in FIG. 12, the at least one heat transfer mesh plates include a first heat transfer mesh plate 200 and two second heat transfer mesh plate 220 that is overlaid on two side of the first heat transfer mesh plate 200. The first heat transfer mesh plate 200 and the second heat transfer mesh plate 220 have different opening ratios. In this embodiment, the opening diameter of the first heat transfer mesh plate 200 is smaller than the opening diameter of the second heat transfer mesh plate 220. Alternatively, opening diameters of the first and the second heat transfer mesh plates 200, 220 can be the same, but the numbers of openings distributed on the first and the second heat transfer mesh plates 200, 220 is different. In this manner, the airflow 140 can be cooled in routes of compression and expansion simultaneously exchanging its heat with meshes.

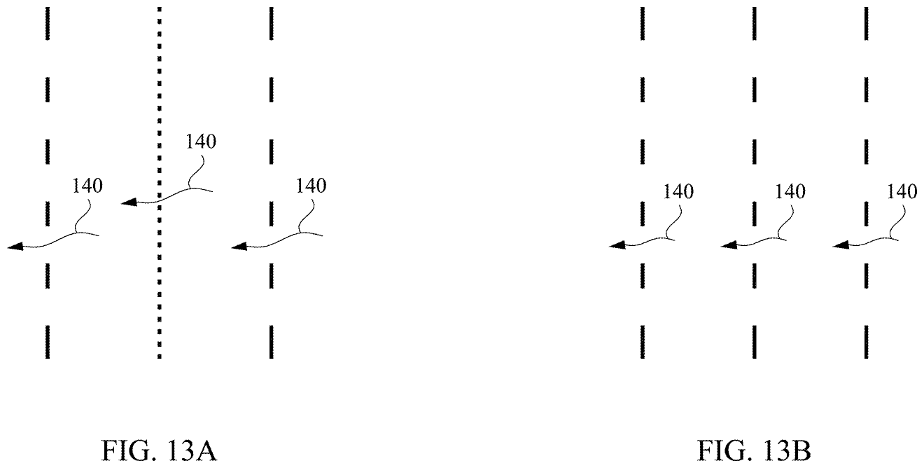

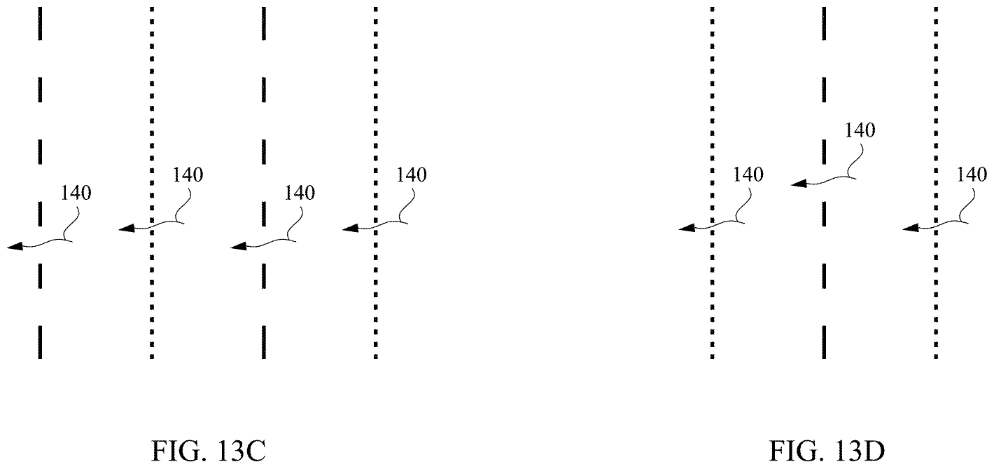

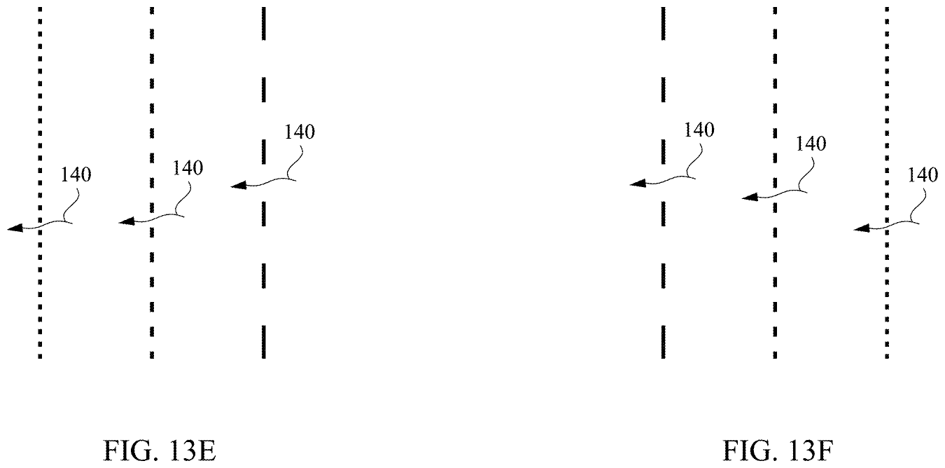

With further reference to FIGS. 13A-13F, FIGS. 13A-13F are exemplary diagrams illustrated the heat transfer mesh plates with different opening ratios in accordance with other embodiments of the present disclosure. Based on different application such as different numbers of cells or housing dimensions, the arrangement of multiple sequentially heat transfer mesh plates, and different configurations of opening ratios can be varied. With such an arrangement, the airflow 140 can obtain an adiabatic expansion and heat exchanging when flowing through the heat transfer mesh plate combinations, thereby decreasing the temperature of the expelled airflow 140 more effectively.

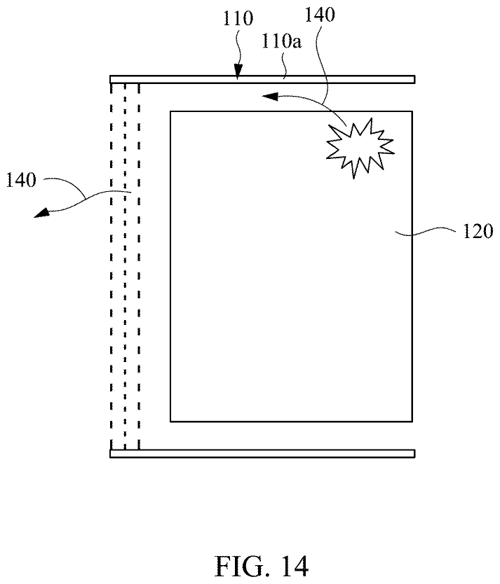

With reference to FIG. 14, FIG. 14 is an exemplary diagram illustrated a partially schematic battery module in accordance with another embodiment of the present disclosure. In this embodiment, the combination of multiple heat transfer mesh plates with different opening ratio replaces the baffle element assembly.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. A battery module comprising:
a housing;
a cell set disposed inside the housing, wherein the cell set and the housing defines at least one flame guiding channel; and
at least one baffle assembly being perpendicular to the flame guiding channel, and having at least slit communicating to the flame guiding channel, which generates routes of compression and expansion for cooling an airflow of a be expelled combustible gas.

2. The battery module as claimed in claim 1, wherein the baffle assembly includes at least one bending baffle structure that creates a compression section, an expansion section or both.

3. The battery module as claimed in claim 1, wherein the baffle assembly includes at least one bending baffle structure that a tension side of bending is protruded inwardly to the cell set; and
a compression side of bending forms an expansion section.

4. The battery module as claimed in claim 1, wherein the baffle assembly includes at least one bending baffle structure that a tension side of bending is protruded outwardly from the cell set; and
a compression side of bending forms a compression section.

5. The battery module as claimed in claim 1, wherein the baffle assembly includes more than two baffle structure, each baffle structure has a first baffle and a second baffle latitudinal spaced apart to each other, wherein the slit is formed between the first baffle and the second baffle.

6. The battery module as claimed in claim 5, wherein the first baffle has a convex portion protruding downwardly and the second baffle has a convex portion protruding upwardly, which defines a compression section and an expansion section respectively at two sides.

7. The battery module as claimed in claim 1, wherein the baffle assembly includes
more than two baffle structures, each baffle structure has a first baffle and a second baffle latitudinal spaced apart to each other;
multiple first slits, each first slit formed between the first baffle and the second baffle of the baffle structures; and
multiple second slits, each second slit formed between the second baffle of one of the baffle structures and the first baffle of the adjacent baffle structure.

8. The battery module as claimed in claim 7, wherein the baffle assembly creates a compression section and an expansion section, wherein
the compression section communicates with the second slits; and
the expansion section communicates with the first slits.

9. The battery module as claimed in claim 1, further comprising at least one heat transfer mesh plate that is paralleled to and is selectively placed at one or both sides of the baffle assembly.

10. The battery module as claimed in claim 9, wherein the at least one heat transfer mesh plate comprises multiple heat transfer mesh plates being parallel-arranged in sequence, and each of the heat transfer mesh plates has at least different opening ratio to the adjacent heat transfer mesh plates.

11. The battery module as claimed in claim 10, wherein the multiple mesh plates are aligned with or without gaps.

12. The battery module as claimed in claim 10, wherein the opening ratio difference is directed to the opening diameter, the number of the openings or both.
